(19) United States
(12) Patent Application Publication
(10) Pub. No.: US 2015/0125835 A1
(43) Pub. Date: May 7, 2015

(54) System and Method for Providing Recursive Feedback During and Assembly Operation

(71) Applicants: David WITTICH, Boca Raton, FL (US); Ken BLACK-STEIN, Lakewood, NJ (US); Barbarba Banks WITTICH, Boca Raton, FL (US)

(72) Inventors: David Wittich, Boca Raton, FL (US); Ken Blackstein, Lakewood, NJ (US); Barbarba Banks-Wittich, Boca Raton, FL (US)

(21) Appl. No.: 14/395,310

(22) PCT Filed: Apr. 17, 2013
(86) PCT No.: PCT/US2013/036950

§ 371 Date: Oct. 17, 2014

Related U.S. Application Data
(60) Provisional application No. 61/687,034, filed on Apr. 17, 2012.
(60) Provisional application No. 61/689,911, filed on Jun. 15, 2012.

(51) Int. Cl. G09B 1/40; G09B 5/06

(52) U.S. Cl. CPC G09B 1/40; G09B 5/065
USPC 434/169; 434/353; 434/335; 434/308

(57) ABSTRACT

The present invention relates to a system and method that includes a camera, a display and a processor wherein the camera captures a series of environmental images of an object, device or structure as the object, device or structure is assembled or constructed and then environmental image sis compared with a reference image. In exemplary embodiments, a reference standard image is displayed and, a user proceeds to manipulate objects to try to conform to the displayed referenced image. Next, environmental images are captured and a processor then compares the detected images against the reference standard and provides feedback to the user in the form of output that reflects compliance with the standard or a deviation from the standard. The feedback is provided, inter alia on a display panel so that the user can either confirm that the assembly is in conformance with the standard or see a graphical representation of how the assembly deviates from the standard. The present invention may be used as a teaching and instructional device, can be used as device to ensure quality control during manufacturing or assembly operations and may be used as an amusement device.

This application claims the benefit of the filing date of U.S. Application No. 61/689,911 and U.S. Application 61/687,034. The present invention relates to a system and method that includes a camera, a display and a processor wherein the camera captures series of images of a device or structure as the device or structure is assembled or constructed. Next a processor then compares the detected images against a standard and provides feedback to a user in the form of output that reflects compliance with the standard or a deviation from the standard. The feedback is provided, inter alia on a display panel so that the user can either confirm that the assembly is in conformance with the standard or see a graphical representation of how the assembly deviates from the standard.

### SUMMARY OF THE INVENTION

The present invention may be used as a teaching or an instructional device, be used as device to ensure quality control during manufacturing or assembly operations or be used as an amusement device.

In preferred embodiments the assembled product is displayed in real time to the user as well as the feedback that shows successful assembly.

In the event that the image captured does not conform to the reference standard alternative audio and visual feedback is provided. The feedback provided may also include further instructions, using the visual display, the audio output device or both. As such the user may be provided instructional information that the user may use to assemble the device in conformance to the standard. Such instructional information may include information relating to the nature of the incorrect orientation of the part or element and a video demonstration of the correct manner in which to orient and integrate the part or element so that the assembly is correct. In the event that the positive feedback is not generated, the user is prompted to reassemble the components until such positive feedback is generated.

In embodiments, the assembly exercise may be subject to time limitations, and if the assembly is not completed before a predetermined time has elapsed, negative feedback is provided.

In other embodiments, the performance of a particular user completing the assembly is associated with a scoring heuristic which may be dependent on time, accuracy or both.

In yet further embodiments, a number of steps may be combined before a feedback step is implemented.

In a contemplated embodiment, the device may comprise a puzzle such as a Rubik's cube or other puzzles including both two dimensional and three dimensional manifestations.

In yet further embodiments, a continuous imaging system such as a video camera is employed and the captured image is displayed to the user in real time.

In a further contemplated embodiment, the assembly and the standard relates to a structure such as a model building. Such models may be created from commercially available materials such as Lego™ brand blocks.

In yet a further embodiment the assembly relates to a repair of a damaged device or article of manufacture.

In yet a further embodiment of the device, the image and reference standard relates to an actual or simulated medical procedures such as a surgical procedure or dental procedure.

In yet a further embodiment, the image of the assembled part is transmitted to a remote location for image processing.

In yet a further embodiment, an expert is located in the remote location along with the images and can provide further feedback to the user that includes audio and visual images of the standard compared with the captured image or images that are displayed to the user in proximity to the assembled device.

The manner in which the captured image is processed and then compared to the standard image can be performed in a plurality of manners and will depend in part on the nature of the assembly or procedure that is to be performed. In an embodiment, an algorithm is applied to the captured image data to convert the characteristics of the data to multidimensional vectors, including and not limited to shape, color, and size.

### BRIEF DESCRIPTION OF DRAWINGS

FIG. 1 is a schematic illustration of the components used in connection with a first embodiment of the invention.

FIG. 1A is a diagram showing the principal components of an illustrative system employing a multi-sensor game console technology.

FIG. 1B is a diagram showing the principal components of an illustrative system employing the laptop computer technology.

FIG. 1C is a diagram showing the principal components of an illustrative system employing tablet computer technology.

FIG. 2 is a block diagram showing an illustrative system for performing the process of the invention according to a first embodiment.

FIG. 2A is a block diagram showing an illustrative system for performing the sub-process of the invention according to a first embodiment related to the selection of a reference standard model.

FIG. 2B is a block diagram showing an illustrative system for performing the sub-process of the invention according to a first embodiment related to loading of a reference standard model.

FIG. 2C is a block diagram showing an illustrative system for performing the sub-process of the invention according to a first embodiment related to the display of a reference standard and a suggested assembly sequence.

FIG. 2D is a block diagram showing an illustrative system for performing the sub-process of the invention according to a first embodiment related to the capture of assembly image data from the creative environment.

FIG. 2E is a block diagram showing an illustrative system for performing the sub-process of the invention according to a first embodiment related to the processing of —image data.

FIG. 2F is a block diagram showing an illustrative system for performing the sub-process of the invention according to a first embodiment related to the comparison of image data with a reference standard.

FIG. 2G is a block diagram showing an illustrative system for performing the sub-process of the invention according to a first embodiment related to providing constructive feedback.

FIG. 2H is a block diagram showing an illustrative system for performing the sub-process of the invention according to a first embodiment related to provide reinforcement feedback.

FIG. 3 is a schematic illustration of an Interactive Guidance Environment User Interface according to a first embodiment of the invention.

FIG. 4A is a schematic illustration of a first display according to the first embodiment of the invention showing a final assembled structure

FIG. 4B is a schematic illustration of a second display according to the first embodiment of the invention showing a component parts kit.

FIG. 5A is a schematic illustration of a third display according to the first embodiment of the invention showing a suggested first action.

FIG. 5B is a schematic illustration of a fourth display according to the first embodiment of the invention showing a suggested first event

FIG. 6A is a schematic illustration of a fifth display according to the first embodiment of the invention depicting suggested subsequent action(s).

FIG. 6B is a schematic illustration of a sixth display according to the first embodiment of the invention depicting suggested subsequent event state(s).

FIG. 7A is a schematic illustration of a seventh display according to the first embodiment of the invention depicting suggested final action(s).

FIG. 7B is a schematic illustration of a eighth display according to the first embodiment of the invention depicting a suggested final event state.

FIG. 8 is a schematic illustration of a ninth display according to the first embodiment of the invention showing the first assembly event capture.

FIG. 9 is a schematic illustration of a tenth display according to the first embodiment of the invention showing a subsequent assembly event capture.

FIG. 10A is a schematic illustration of an eleventh display according to the first embodiment of the invention showing a proactive environment deviation alert overlay.

FIG. 10B is a schematic illustration of a twelfth display according to the first embodiment of the invention showing a proactive environment corrective action overlay.

FIG. 10C is a schematic illustration of a thirteenth display according to the first embodiment of the invention showing capture of a final assembly event sequence.

FIG. 10D is a schematic illustration of a fourteenth display according to the first embodiment of the invention showing a successfully completed final assembly image capture from the real time creative environment.

FIG. 11 is a schematic illustration of the applied block vertice(s) markings according to the first embodiment of the invention.

FIG. 12 is a diagram showing the principal components of an illustrative system employing a smart phone in communication with an internet ready smart television technology.

FIG. 13 is a schematic illustration of a toy block with an imbedded transmitter at diagonal vertices locations according to a subsequent embodiment of the invention.

FIG. 14 is a schematic illustration of a further display according to the first embodiment of the invention showing a successfully configured block structure image capture and reinforcement feedback

FIG. 15 is a diagram showing the principal components of an illustrative system employing a tablet computer, lettered block set, play mat, tablet PC display cradle, and user interface application software.

FIG. 16 is a schematic illustration of a sixteenth display according to the first embodiment of the invention showing an image capture display of a successfully configured block pattern and reinforcement feedback.

FIG. 17 is a schematic illustration of a processor and related peripherals on which the invention can be implemented.

### DETAILED DESCRIPTION OF THE INVENTION

The description of the invention herein is intended to provide information for one skilled in the art to understand and practice the full scope of the invention, but is not intended to be limiting as to the scope of available knowledge, nor admit that any particular reference, nor the combinations and analysis of this information as presented herein, is itself a part of the prior art. Any of the references cited herein are expressly incorporated herein by reference, as if the entirety thereof was recited completely herein. The present invention is not limited by a narrow or precise discussion or the examples provided herein, nor is it intended that any disclaimer, limitation, or mandatory language as applied to any embodiment or embodiments be considered to limit the scope of the invention as a whole. The scope of the invention is therefore to be construed as the entire literal scope of the claims, as well as any equivalents thereof. It is also understood that the title, abstract, field of the invention, and dependent claims are not intended to, and do not, limit the scope of the independent claims.

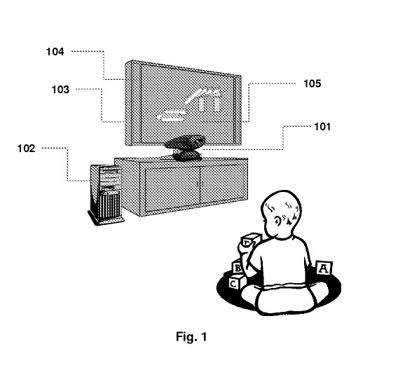

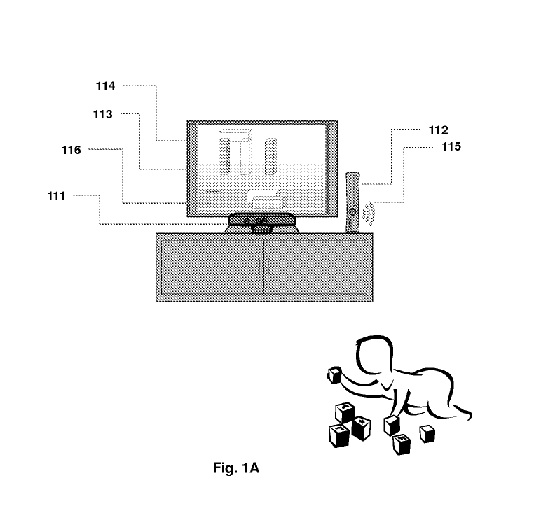

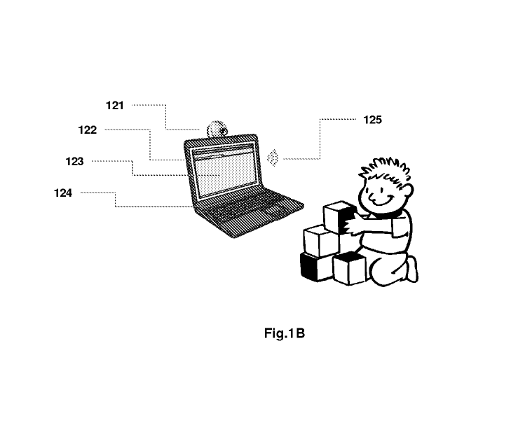

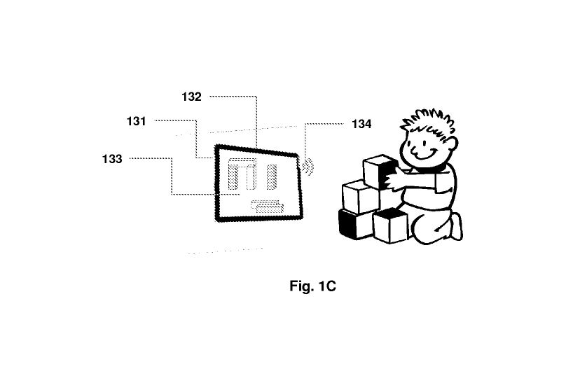

Referring now to FIG. 1, a first embodiment of the present technology includes an optical sensor 101, a computer 102 including a processor and data storage medium, and output devices 103 including a display panel 105 and a loudspeaker system 104. As depicted in FIG. 1, optical sensor 1101 is a digital camera having a resolution of 320 by 200 pixels (color or black and white) that stares out, grabbing frames of environmental image data five times per second and storing the same in one or more frame buffers. At preselected times, a frame of the environmental image data is captured, transmitted to the processor and then analyzed by a computer 102 and compared to a standard reference image or images. The environmental image can be captured and stored from a video feed using known frame grabber technology. For example, frame grabber technology is available from Epiphan Systems Inc., of Ottawa ON Canada, EPIX, Inc. of Buffalo Grove, Il and Foresight Imaging or Chelmsford, Mass. In its basic form, the comparison of the images involves first processing the data so certain attributes conform to predetermined vectors using an algorithm, such as a geometric shape or other pre-designated shape, and the orientation of the shape, and the size, coloring and shading of the shape. In embodiments, the frame grab step or the step in which the environmental images is captured is performed manually by the user. The analysis of the image data can be accomplished in a number of manners. As disclosed herein the digital image processing relies on general purpose microprocessors that are programmed by suitable software instructions to perform the necessary analysis. In alternative embodiments, other arrangements, such as using dedicated hardware, reprogrammable gate arrays, or other techniques, can also be used. The comparison process usually entails three steps: In the first, the object or target member is located within the frame. In the second step the object's orientation is discerned. In a third step, the features of the object are extracted and processed into multidimensional vectors. The vector representing each image is then compared with the standard vector or reference vectors to determine if the characteristics have sufficient similarity to be regarded as a match. The comparison step may be implemented by the use of a lookup table within the processed data is compared with a database of item as vectors having known attributes. In addition, a further step can be implemented wherein the comparison is adjusted depending on the nature of the comparison that is made and the need for or absence of false positives.

Now referring to FIG. 1B, an alternative embodiment of the invention, the processing software is executed on a personal computer. Laptop computer 122 includes a camera 121, a display 123, a keyboard 124 and a loudspeaker 125.

Now referring to FIG. 1C, in an alternative embodiment of the invention, the processing software is executed on a tablet computer 133 that includes a camera 132, a display 131, and a loudspeaker 134. The tablet computer uses touchscreen technology to provide input for control functions. Such control functions may include the selection of the reference standard image, the display of an instructional sequence, timing of the frame grabbing function from the video feed, and when and how positive and negative feedback is outputted. The control function may also activate a timer feature wherein the assembly operation is timed and scored and the score can then be compared against other scores in a game environment.

According to a first embodiment of the invention, information relating to a standard with respect to an assembled device or a plurality of standards with respect to a reference assembled device is provided as input to a database or other data storage system that can be accessed by a processor. In addition to the database or data storage system, the system includes a video camera for the detection of images, a user input device and a display panel. To use the device, a user of the system first selects a reference device using the user input device that will serve as the standard for the intended device to be assembled. Information relating to the reference device may be selected from a menu or may be downloaded from the internet through a website that is designed to provide data for the application. Next, the user is prompted to initiate an assembly process for the device in front of the camera or other image capturing device. As each part is integrated to the device, the camera will capture an image of the partially assembled device or structure. The image capturing step may be controlled by the user or automatically triggered by the absence of motion in a captured video frame. In this regard, the camera may be triggered by the user or, if the camera is comprised of a video device, the image may be captured by automatically saving a particular static image after the absence of motion is detected after a predetermined time has elapsed. In further embodiments, either the device or the camera may be oriented so that multiple views of the partially assembled device may be captured during the assembly process. The data from the camera is then transmitted to the processor for comparison with the reference standard.

In an embodiment, after each step in the assembly process is completed, an image is captured and then compared to the reference standard. If the assembled product conforms to the standard at each step, positive feedback is generated to reflect that the step has been successfully completed. This feedback may comprise of audio signals such as a chime, and additional visual feedback may be displayed to the user on the display. In an embodiment wherein the method involves the assembly of a device, an image of the device is displayed for each assembly step in conjunction with an outline superimposed on the image that conforms to the outer edge or periphery of the reference standard device using a dotted line in a first color such as white. If the assembly is correct, the image will be shown within the confines of the standard outline superimposed on the display. If the assembly is incorrect, the part of the assembly that does not conform is highlighted by superimposing an outline of the non-conforming part on the device in a second color on the display, such as red.

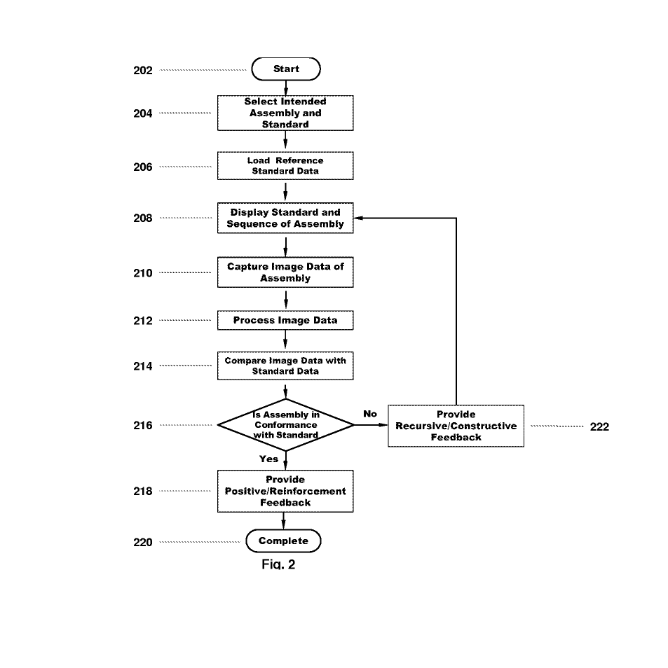

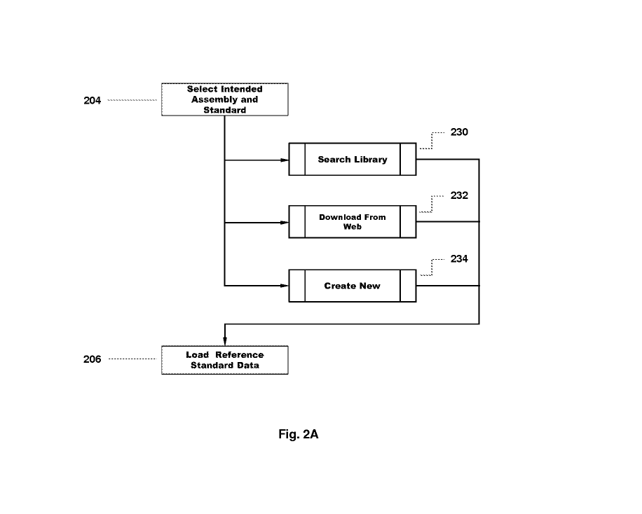

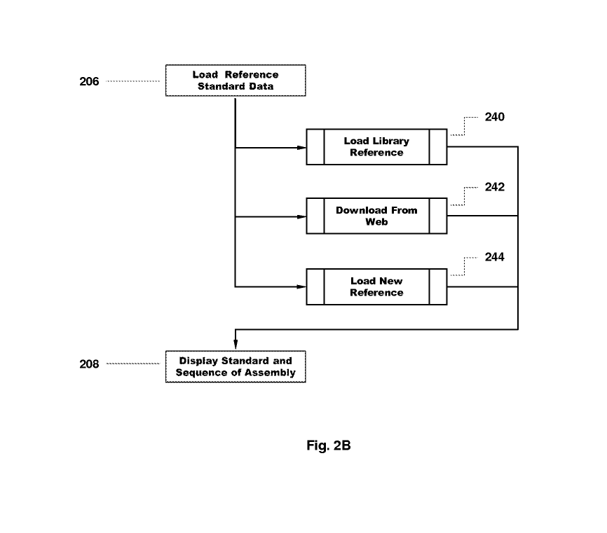

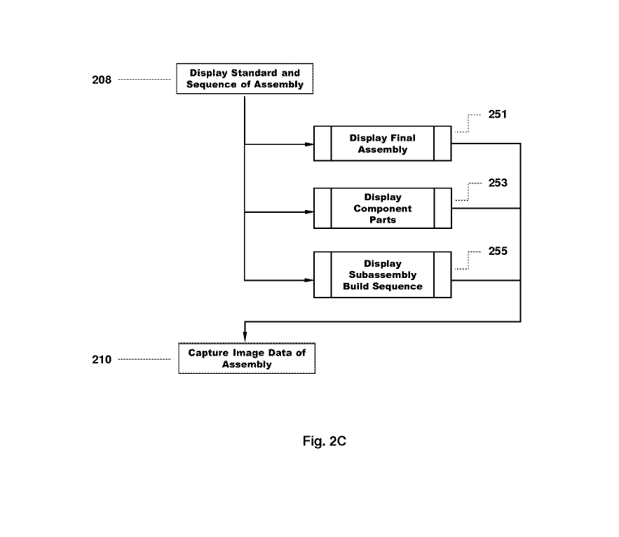

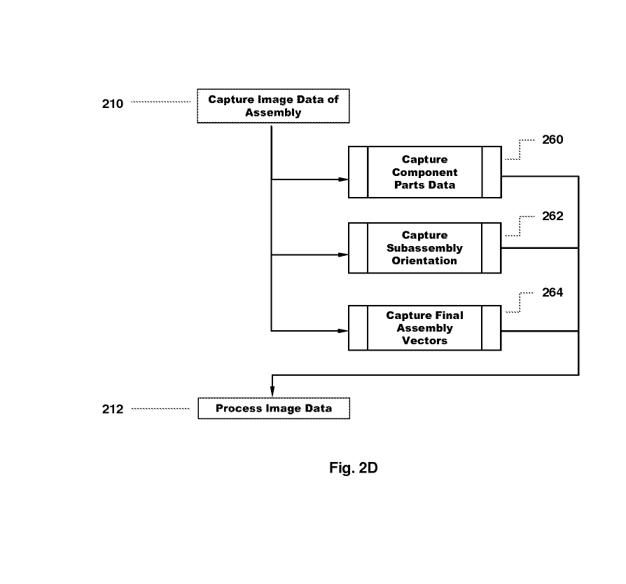

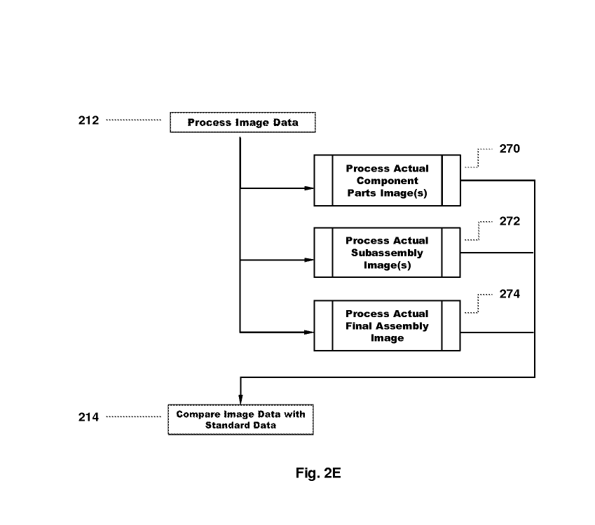

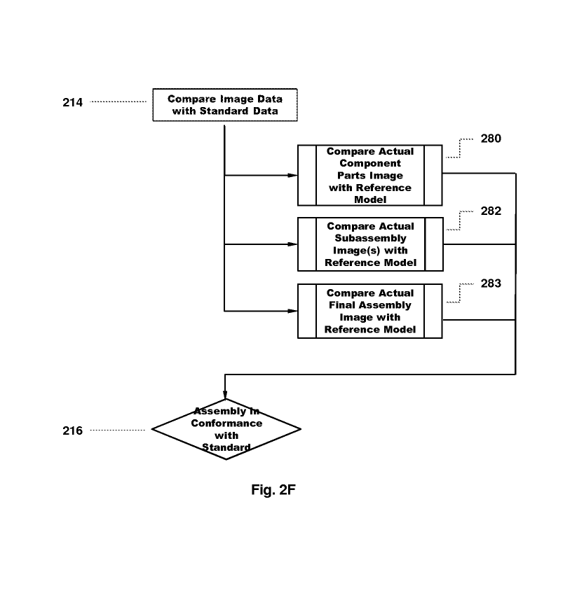

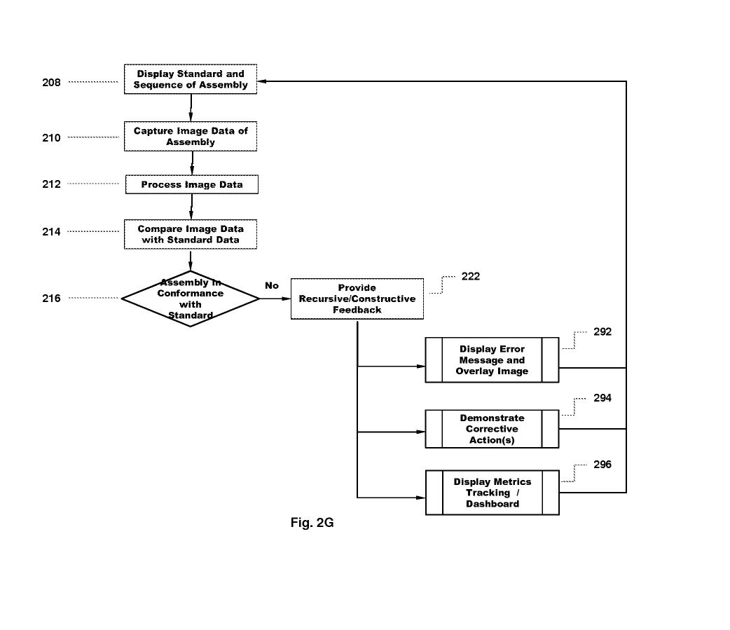

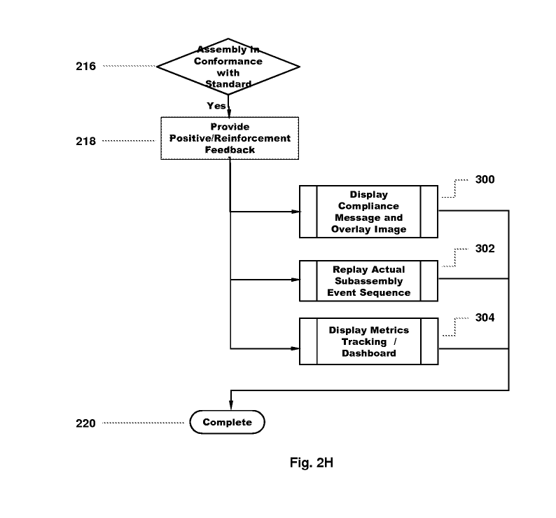

Now referring to FIG. 2, a flow chart depicts steps according to a method of the invention. Upon the activation of the device after start 202, a user is first prompted to select a standard from a menu of predetermined standards at step 204. Next, in step 206 data from the standard is transferred from a memory or database into a cache. The user is then provided with a display of the standard and the sequence of assembly in step 208. In addition, the user may be provided with audio instructions relating to the assembly. In alternative embodiments the user may be proved with an audio video file that illustrates the invention. In next step 210, as the user assembles the device, the camera captures images of the assembly as it is assembled. At predetermined steps, frames are captured and processed in step 212. The processed images are then compared with the reference standard at step 214 using the processor. At step 216, if the captured image is in conformance with the standard the user is provided with positive feedback at step 218 which may include visual information that confirms to the user that the assembly step was successfully completed and audio feedback such as a chime. The assembly step is processed and then completed at step 220. Next the user proceeds to the next assembly step. If the captured image is not in conformance with the standard at step 216, the user is provided with negative feedback and again displayed the standard at step 208 and the method proceeds from step 208.

Referring now to FIG. 2A, in an alternative embodiments, the reference standard step 204 is retrieved from an internet website source and accordingly, the steps further include may alternatively include (1) a search of a database, local memory or data reading device such as a disk or memory device 230 for a reference standard, (2) a download step 232 from the internet wherein the standard is downloaded to the data cache associated with the processor a new step 103 or (3) as depicted in step 234 a newly created standard is created by the user as. The standard is then loaded to the local caches at step 238.

As illustrated in FIG. 2B, in addition to the reference standard, assembly instructions or the sequence of assembly steps are also accessed by the processor from the reference library at step 240, at step 240, downloaded from the internet at step 242 or created by the user at step 244. This data is downloaded to the computer at step 250 and displayed to the user.

As illustrated in FIG. 2C, the display step may alternatively comprise (1) a display of the assembly after completion in step 251, or (2) alternatively, each of the components of the assembly may be displayed at step 253, or (3) a subassembly build sequence may be displayed as depicted in step 255.

FIG. 2D depicts sub-steps of data capture step 210. In a first sub-step 260 the camera captures data relating to each of the component parts, in a second step 262, that may be simultaneously executed with the other data capturing steps, data relating to the orientation of the subassembly is captured. Step 264 depicts the step of capturing the final assembly vectors.

FIG. 2E depicts sub-steps that are associated with the image processing steps 212 and include (1) a step 270 directed to processing of the image from the various parts assembled in the captured images, (2) a step 272 wherein the subassembly images are processed from intermediate steps in the assembly sequence and (3) a step 274 wherein images from the final subassembly are processed.

Now referring to FIG. 2F, sub-processing step 280 is depicted wherein the captured component parts are compared with the component parts from the reference standard. Step 282 refers to an image processing step wherein the assembled subassembly is compared to the assembled sub-assembly found in the reference standard. Finally, step 283 depicts a comparison of the final assembly as assembled by the user to the final assembly provided in the reference standard.

FIG. 2G depicts sub-steps associated with step 222 including step 292 wherein an error message is displayed in response to the processor output reflecting that the assembly is not in conformance with the reference standard; step 294 wherein the processor demonstrates corrective action by providing as display of the correct subassembly and subassembly steps; and step 296 that is directed to providing metrics to a tracking dashboard that is also provided on the display.

FIG. 2H depicts sub-steps associated with step 218 wherein positive feedback is provided to the user including step 300 wherein the processor displays both a message of compliance with the standard and an overlay of the standard image with the assembled part. Step 302 involves the replay of the assembly sequence to provide positive reinforcement to the user. Step 304 is directed to providing a display of the metrics of the subassembly process to a tracking dashboard that is displayed to the user. Such metrics may include the time elapsed to successfully compete the assembly step and the number of attempts made by the user.

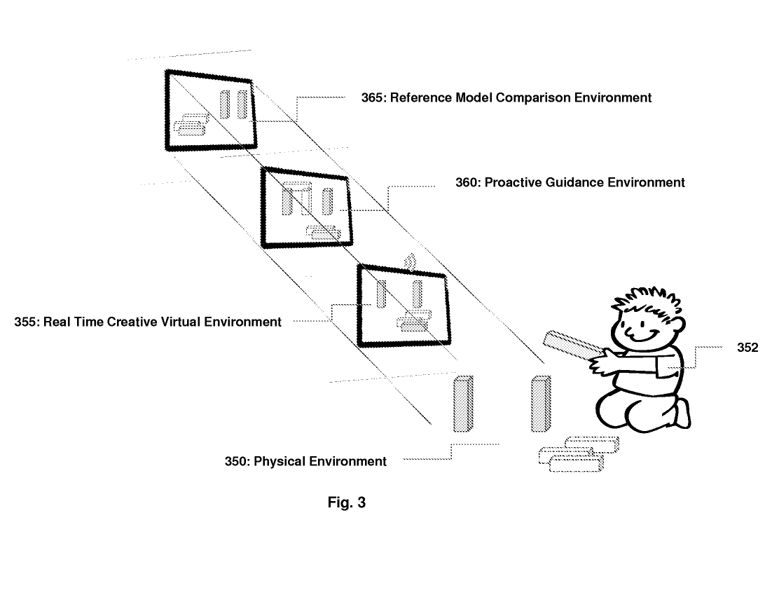

Now referring to FIG. 3, a schematic of an embodiment of the embodiment depicts the elements 350 of an assembly to be assembled by a user 352. User 352 is depicted manipulated the elements 350 at 353. The display communicates information to the user information including a reference model comparison environment 365, a display proving proactive guidance for the user 360, and a real time display 355 depicting of the environment in which the user manipulates the elements in the physical environment.

FIG. 4A depicts an illustration of a reference standard in an assembled condition according to an embodiment of the invention that includes three elements 400, 401 and 402. FIG. 4B depicts each of the elements 400, 401 and 402 in an unassembled position and reflects data regarding the reference model or standard. FIG. 5A is a schematic illustration of a first action that is which reflects the motion that should be applied to the element 402, including positioned 402a through 402e conform the reference standard reflected in FIG. 4A. FIG. 5B depicts the step after completion and provides the reference a standard of element 402 for the first step and shows the previous location and orientation of element 402 in position and its starting position in depicted in phantom 402a.

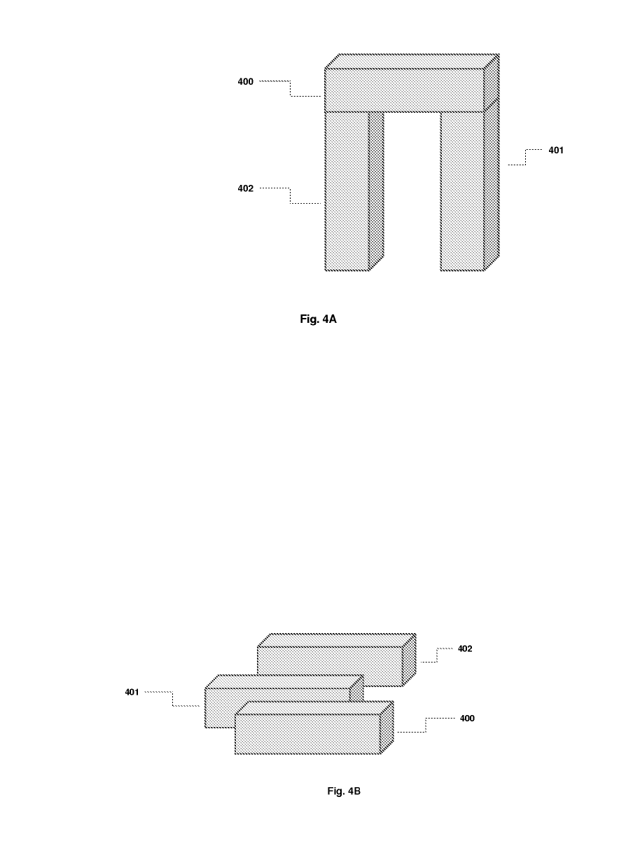

FIG. 6A depicts the sequence of assembly for element 401 wherein the starting position 401 is depicted in phantom as well as locations 401b-401f which depicts the motion that is may be implemented to put the part 401 into position 401 in conformance with the reference standard. Element 402 is also shown in position in conformance with the reference standard.

FIG. 6b depicts the parts of the assembly wherein element 402 and 401 are in the position in conformance with the reference standard. 401a and 402a depict the elements in phantom reflecting the starting position of the elements.

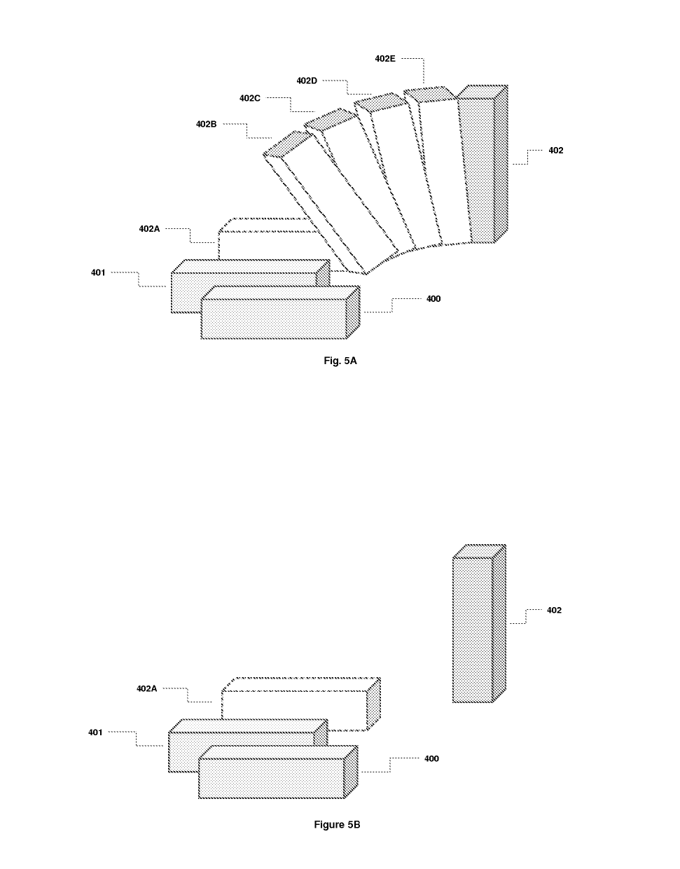

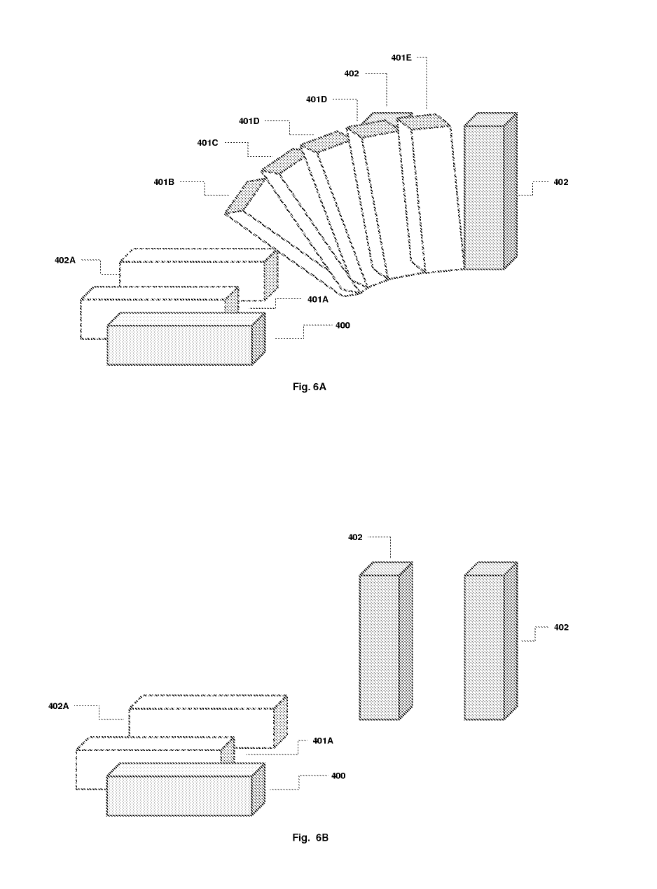

FIG. 7A depicts the final action wherein element 400 is placed in position in conformance with the standard. Illustration 7A depicts a sequence of positions 400b-400e and the element at its final correct position on top of elements 400 and 401. The position of the element before the motion has been applied is shown in phantom 402a, 401a and 400a.

FIG. 7B depicts the assembled structure 500 comprised of elements 401, 402 and 403 which is in conformance with the reference standard. The location of the elements 400a, 401a and 402a before the completion of the assembly steps is also depicted in the FIG. 7B in phantom.

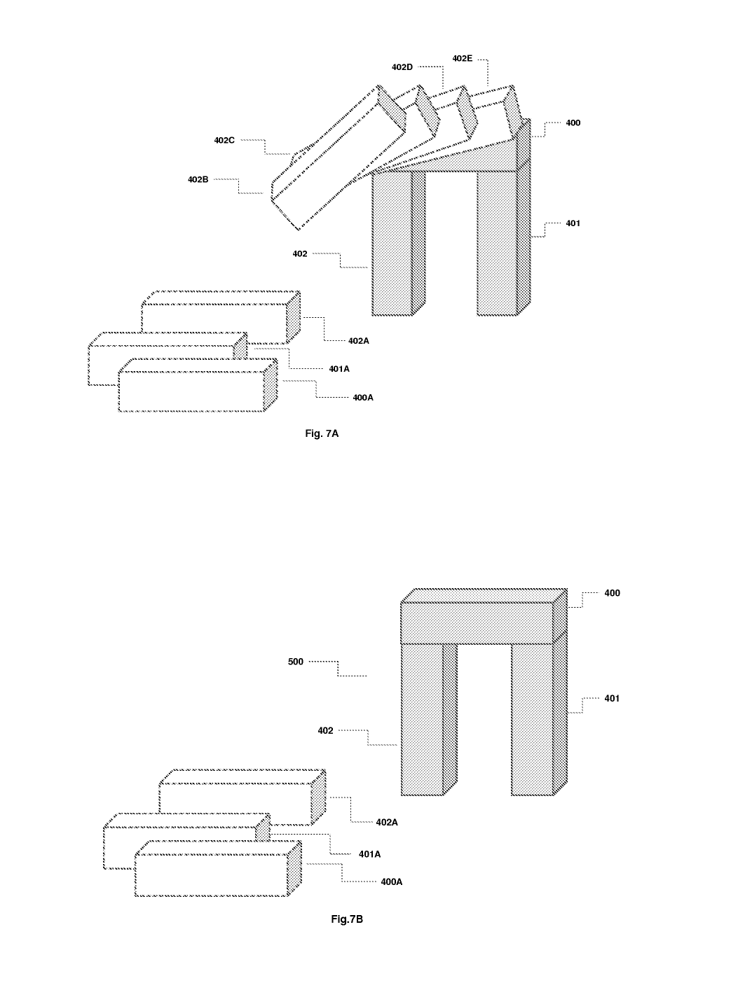

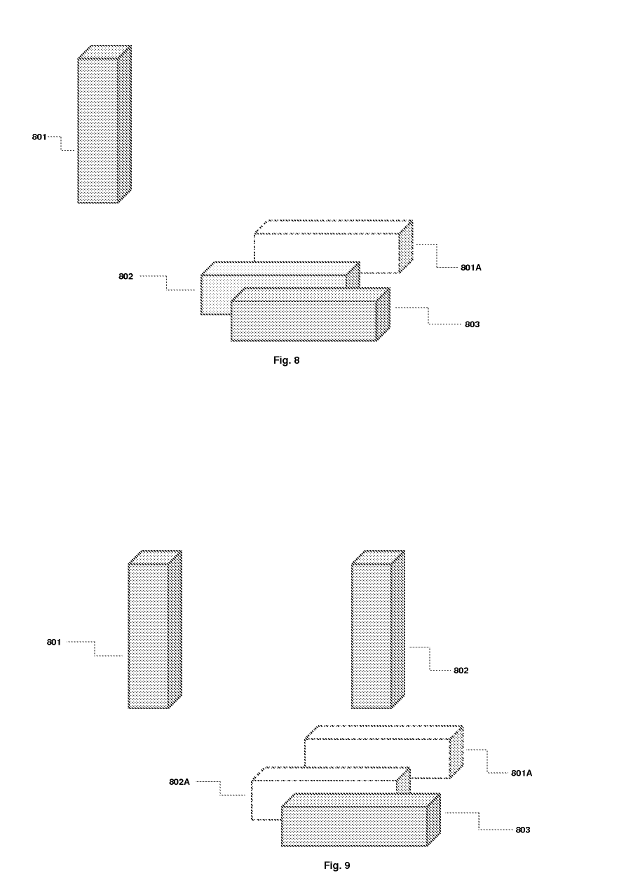

FIGS. 8-10 depicts a series of illustrations that depicts steps that lead to the unsuccessful assembly of the structure in conformance with the reference standard. Thus in FIG. 8 a first element 801 is depicted in a first assembled position. Element 801a depicts the element in the starting position. Now referring to FIG. 9, elements 801 and 802 are depicted after a second step of an assembled position. The starting position of element 801a and 802a are depicted in phantom. The positions of elements 801 and 802 are not in conformance with the reference standard.

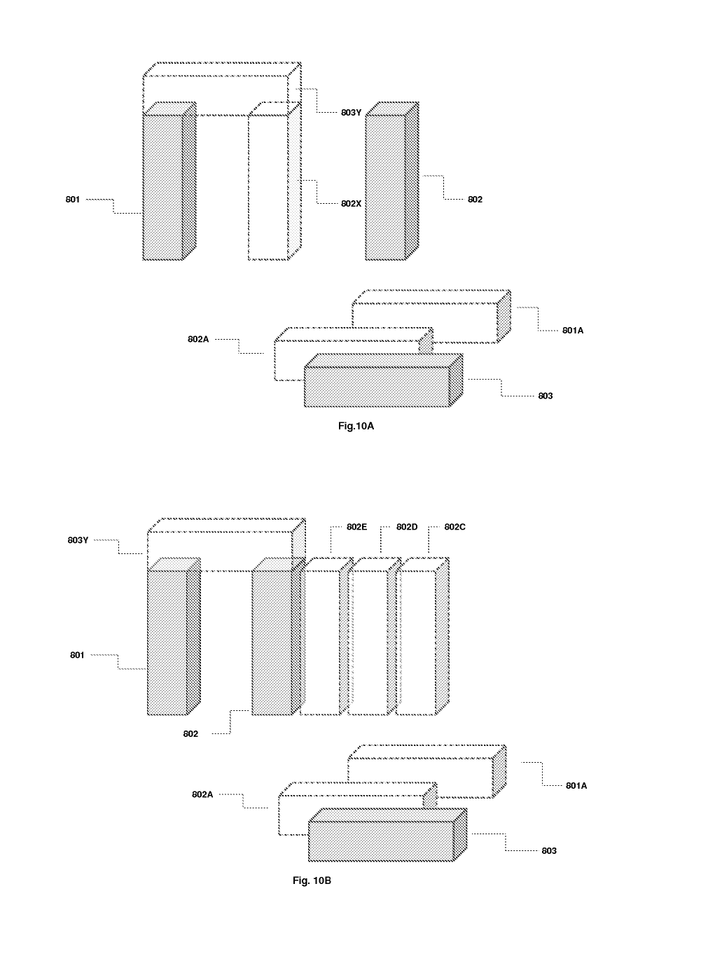

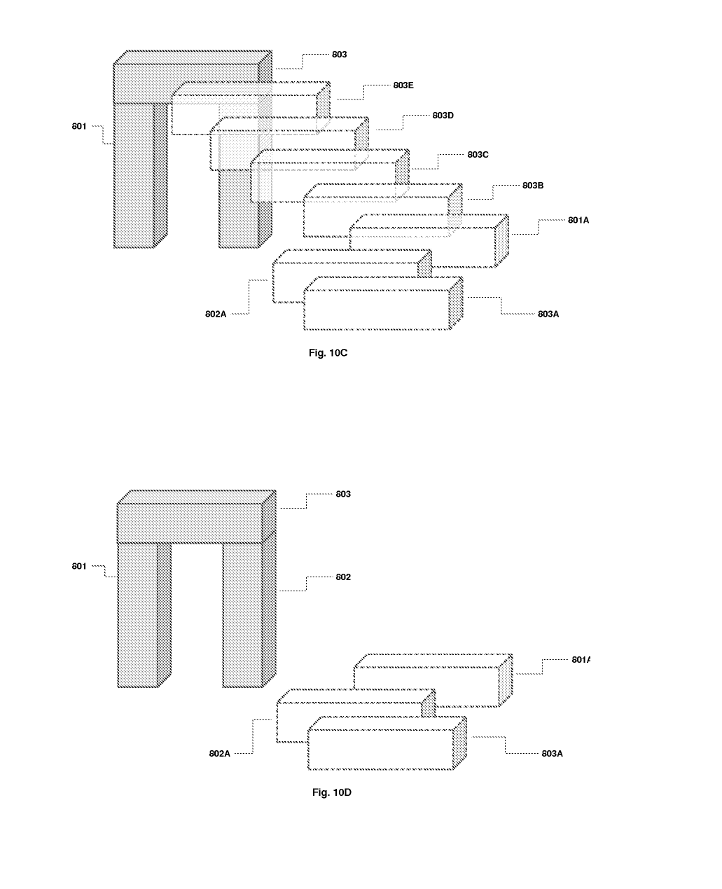

FIG. 10A depicts assembled components 801 and 802 in the assembled incorrect position. Depicted in phantom are element 802x and 803y in the correct position in conformance with the standard.

FIG. 10B depicts a series of steps wherein the element 802 is moved to position 802c, 802d and 802e that illustrates how element 802 can be repositioned to reach the correct position reflected by element 802 and reach conformance with the reference standard.

FIG. 10C illustrates a series of sub-steps wherein element 803 is moved from its starting position 803a to its completed correct position 803 through the series of positions 803b-803d.

FIG. 10D depicts the assembled structure, including elements 801, 802 and 803 in conformance with the reference standard. The starting position of the elements 810a, 802a and 803a is shown in phantom.

Thus in a first example, an application is activated on a computer 102, wherein the system includes camera 101. In response to a start command, the display will provide information relating to a standard. The display will provide a sequence of images, including the elements, the sequences of steps to reach the reference standard and the reference standard.

Next, a user will manipulate three dimensional objects in an attempt to replicate the standard. The camera captures images of the work and displays the images on the display in real time. At the same time, the processor executes an algorithm to characterize the features of the image and then compare the features to the reference standard. In this example, the comparison is executed when the processor detects the absence of motion in the transmitted image after a predetermined time. The processor then compares the last image captured to the reference standard. If the captured image is consistent with the reference standard, the will display an outline that reflects the successful. In this embodiment if the processor detects the successful completion of the first step, signal is sent to a speaker that will provide an audio signal that reflects positive feedback such as a bell or chime. If the processor fails to detect the successful completion of a step, an alternative signal is provided. In the event the step is successfully completed, the user can proceed to a second step and the process is repeated but a reference standard is altered to a second reference standard. This sequence is repeated until the assembly is completed.

If the user fails to, the user is given an opportunity to again assemble the device and present the device to the camera for imaging. The processor will then compare the reassembled device to the first reference standard.

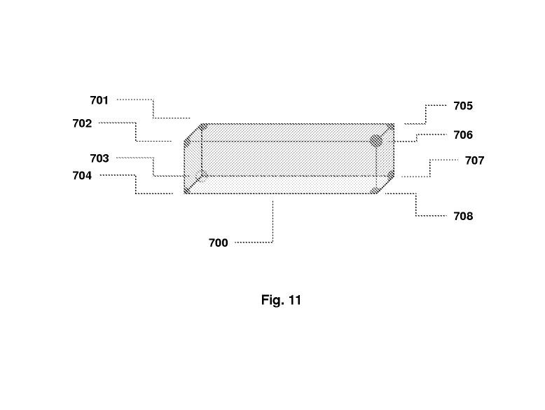

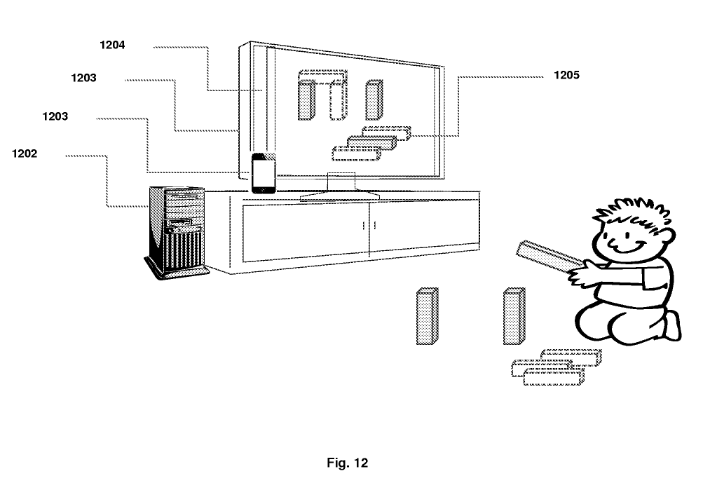

Now referring to FIG. 11, in a further embodiment of the invention the parts of the assembly 700 are provided with a plurality of indicators 701-708 provided at the intersection of each of the vertices of the part 700. These indicators may be provided to the user along with the software to operate the system in the form a sheet of self-adhesive stickers along with directions that instruct the user to place the stickers at designated locations. The use of such indicators allows the processor to rapidly compute and extract the features of the object. In embodiments, a plurality of parts such as blocks or letters is also provided to the user as well as a mat. The stickers are placed upon the parts at pre-designated locations to allow rapid processing of the detected images.

While the example discussed above involves the manipulation of three dimensional object in a physical environment, in other embodiments the assembly may be achieved in a virtual environment. Accordingly, a user may select a reference standard and, following a series of assembly steps using virtual elements. In addition, while embodiments discussed above are directed to the manipulation of both real and virtual objects, in a further embodiment the standard may be directed to a preferred body positions and body movement. In this contemplated embodiment, the user may select a preferred reference standard, such as a golf swing and then attempt to replicate the motion in front of the camera. The camera can then compare the captured images against the reference standard. In yet further embodiments, the degree of deviation from the standard assembly or standard motion can be calculated and assigned a value. This value can then be displayed to the user in the form of a score. In yet further embodiments, the computer will measure the time elapsed for each step in an assembly process to be successfully completed and the time can be displayed t the user in the form of a score. In yet further embodiments a countdown display may be provide and the user is prompted to complete an assembly process in conformance with a standard that is displayed before the countdown has elapsed.

### Data Processing

A method that can be used to detect features in an image and then compare the features is referred to as Scale-invariant feature transform (or SIFT) which employs an algorithm for computer vision for the detection of local features that are present in detected images. The algorithm, which was published by David Lowe in 1999 in a paper entitled “Object recognition from local scale-invariant features,” Proceedings of the International Conference on Computer Vision. pp. 1150-1157. doi:10.1109/ICCV.1999 is further described in U.S. Pat. No. 6,711,293 “Method and apparatus for identifying scale invariant features in an image and use of same for locating an object in an image.” which is incorporated by reference herein. The SIFT algorithm may be used for object recognition, as well as video tracking, and match moving.

In summary, the algorithm behind the SIFT keypoints technique first extracts features from a set of reference images of objects that are stored in a database. Features of a new object may be recognized in the new image by individually comparing each new feature from the new image to the database and candidate matching features based on Euclidean distance of their feature vectors are determined. From the full set of matches, subsets of keypoints that agree on the object and its location, scale, and orientation in the new image are identified to filter out good matches. The determination of consistent clusters may be rapidly implemented by the use of a hash table implementation of the generalized Hough transform algorithm. Each cluster of 3 or more features that agree on an object and its pose is then subject to further detailed model verification and subsequently outliers are discarded. Finally the probability that a particular set of features indicates the presence of an object is computed, given the accuracy of fit and number of probable false matches. Object matches that pass all these tests can be identified as correct with high confidence. Using the SIFT algorithm, distinctive keypoints may be selected that that are invariant to location, scale and rotation, and which are robust to affine transformations (changes in scale, rotation, shear and position) and changes in illumination for object recognition. The sequence proceeds as follows:

First, SIFT features are obtained from the input image using the algorithm described above. Next the features from the input image are matched to the SIFT feature database of reference or standard images that has been created. In an embodiment the feature matching is done through a Euclidean-distance based nearest neighbor approach. To increase robustness, matches are rejected for those keypoints for which the ratio of the nearest neighbor distance to the second nearest neighbor distance is greater than 0.8. To avoid the processor expensive search required for finding the Euclidean-distance-based nearest neighbor, an approximate algorithm called the best-bin-first algorithm is then employed. See Beis, J. Lowe, David G.; Shape Indexing using approximate nearest neighbor search in high dimensional spaces,” Conference on Computer Vision and Pattern Recognition, Puerto Rico; Sn pp1000-1006. doi 10.110/CPVR 1997 609451 which is incorporated by reference herein.

To further increase the reliability of the matching step the Hough transform is applied to create clusters of those features that belong to the same object and reject the matches that are left out in the clustering process. When clusters of features are found to vote for the same pose of an object, the probability of the interpretation being correct is much higher than for any single feature. Each keypoint votes for the set of object poses that are consistent with the keypoint's location, scale, and orientation. Bins that accumulate at least 3 votes are identified as candidate object/pose matches.

Finally, for each candidate cluster, a least-squares solution for the best estimated affine projection parameters relating to the reference image to the input image is obtained. If the projection of a keypoint through these parameters lies within half the error range that was used for the parameters in the Hough Transform bins, the keypoint match is kept. If fewer than 3 points remain after discarding outliers for a bin, then the object match is rejected. The least-squares fitting is repeated until no more rejections take place.

Additional information relating to the implementation of keypoint recognition systems can be found in the articles by K. Mikolajczyk and C. Schmid, “An Affine Invariant Interest Point Detector,” In European Conference on Computer Vision, pages 128-142. Springer, 2002. Copenhagen; K. Mikolajczyk and C. Schmid. A Performance Evaluation of Local Descriptors. In Conference on Computer Vision and Pattern Recognition, pages 257-263, June 2003; K. Mikolajczyk, T. Tuytelaars, C. Schmid, A. Zisserman, J. Matas, F. Schaffalitzky, T. Kadir, and L. Van Gool. A Comparison of Affine Region detectors. Accepted to International Journal of Computer Vision, 2005 and which are incorporated by reference herein. Software that implements a keypoint technique is sold under the brand “ImageModeler” which is available from Realviz Corporation, Arep Center, 1 traverse des Brucs 06560 Sophia Antipolis Cedex, France that allows semi-automated 3D reconstruction from a number of separate and distinct views.

An alternative method to compare image data involves the creation of feature histograms for each image, and the selecting an reference or standard image with the histogram closest to the input image's histogram. This technique may use three color histograms (red, green, and blue), and two texture histograms, direction and scale. This technique works best with images that are very similar to the database images. If the image requires significant efforts to replicate the scaled, or requires rotation of the images do not match, the method is not as effective. The computation of color histograms is fairly straightforward and requires the first selection of a range for your “histogram buckets.” For each range, the number of pixels with a color in that range are calculated. As an example, a “green” histogram is created using four buckets—0-63, 64-127, 128-191, and 192-255. For each pixel of the captured image the green value is analyzed and the number is added to the appropriate bucket. After the results are calculated, each bucket is divided by the total by the number of pixels in the entire image to get a normalized histogram for the green channel.

For creating a texture direction histogram, the edges of the image are first detected. For each edge point, has a normal vector pointing in the direction perpendicular to the edge. Next the normal vector's angle is quantized into one of 6 buckets between 0 and pi (since edges have 180-degree symmetry, the angels are converted between −pi and 0 to be between 0 and PI). The number of edge points in each direction is calculated and the result is an un-normalized histogram representing texture direction. This can then be normalized by dividing each bucket by the total number of edge points in the image.

To compute a texture scale histogram, for each edge point, we measured the distance to the next-closest edge point with the same direction. For example, if edge point A has a direction of 45 degrees, the algorithm walks in that direction until it finds another edge point with a direction of 45 degrees (or within a reasonable deviation). After computing this distance for each edge point, we dump those values into a histogram and normalize it by dividing by the total number of edge points. The five histograms for each image as discussed can then be compared by two images by taking the absolute value of the difference between each histogram bucket, and then sum these values.

In yet a further alternative technology that may be advantageously used with the invention is reported in a paper entitled “Keypoint Recognition using Randomized Trees” by Vincent Lepetit and Pascal Fual, Ecole Polytechnique Federale de Lausanne (EPFL) Computer Vision Laboratory, CH-1015 Lausanne, Switzerland (Vincent.Lepetit, Pascal.Fua}@epfl.ch, http://cvlab.epfl.ch. which is also incorporated by reference herein. This paper discloses a keypoint-based approach that is effective in this context by formulating wide-baseline matching of keypoints extracted from the input images to those found in the model images as a classification problem. This shifts much of the computational burden to a training phase, without sacrificing recognition performance. The resulting algorithm is robust, accurate, and fast-enough for frame-rate performance. See also, Fast Keypoint Recognition using Random Ferns—faster and more scalable than Lepetit 06.

In a further embodiment, the software platform to operate the device is based upon the Microsoft's Kinect software and its software development kit (SDK). The SDK released by Microsoft includes Windows 7 compatible drivers for its Kinect device which includes a camera and processor. The software kit provides Kinect capabilities to developers to allow them to build applications with using C++, C# or Visual Basic using using Microsoft Visual Studio. Features included in the SDK kit include raw sensor streams and access to low-level data streams from a depth sensor, a color camera sensor, and a microphone array. An element location sensor can be optimized to locate an enhanced detection element as discussed below. While the Kinect system is focused and optimized for skeletal tracking, embodiments of the present invention can be directed to teaching body position wherein the reference standard may be directed to body movements such as those that may be implemented in dance, exercise, and sports. For example, the reference standard may be directed to a golf swing or swimming stroke. The user then attempts to replicate the body position and the processor will compare the reference standard against the detected body motion and position. The development kit provided by Microsoft further includes sample code and requisite documentation.

Now referring to FIG. 12, in a further embodiment of the invention, the image capturing device is smart phone 1202 that is in communication with processor 1202. The system further includes display 120 on which is displayed one of the images to assist the user to complete the assembly sequence in conformance with the reference standard. The captured images includes a display of blocks 1215 and 1216 which reflect an image captured of blocks 1220 and 1221 in the environment. The blocks shown in phantom 1230 and 1231 depict suggested solutions to the assembly operation.

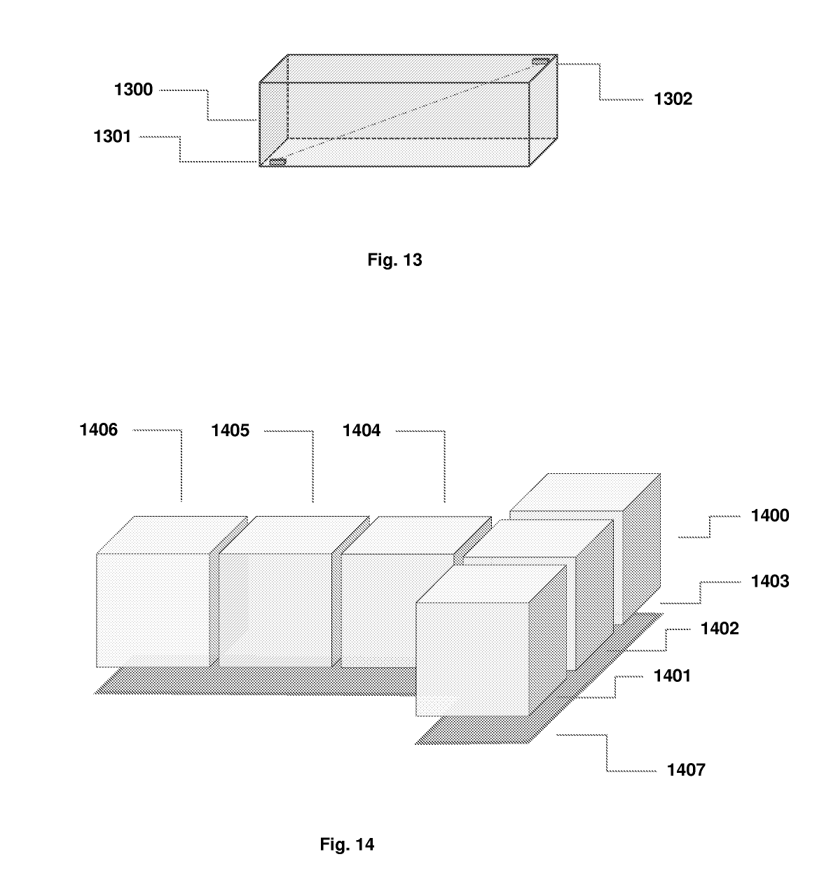

FIG. 13 depicts an embodiment of the invention wherein block 1300 is provided with enhanced detection elements in the form of transmitters 1301 and 1302 at opposite corners. The transmitter may be an active micro transmitter or use RFID passive technology. In this embodiment the system of the invention further includes an antenna, or plurality of antennae and signal processing software to correlate the location of the transmitters in the physical environment and to correlate each of a plurality of transmitters with respect to each other. Using the transmitter, the location of the blocks may be detected. In embodiments the transmission antennae may be multi-dipole that is adapted to receive a number of bandwidths. The transmission band may be super low frequency, ultra low frequency, very low frequency, low frequency, medium frequency, high frequency, very high frequency, ultra high frequency, or any other. For example, a frequency used in the connection with the 802.11 standard or blue tooth standard may be employed with the invention. Each transmitted signals includes data to distinguish the block and the transmitters associated with each blocks from the others in a set provided to the user. The system is provided with a signal processing program that provides for radiolocation. Radiolocation refers to the process of finding the location of a transmitter by means of the propagation properties of the waves it transmits. In addition, the angle, at which a signal is received and the time it takes to propagate can contribute to the determination of the location of the transmission. There are a variety of methods that may be employed to determine the location of a transmission which include: 1) the assisted-global positioning satellite (GPS) technology utilizing a GPS chipset in a mobile communication facility, 2) standard GPS technology, 3) enhanced-observed time difference methods using software that uses the time differences of signal transmission received by geographically dispersed radio receivers or antennas determine a transmission location, 4) time difference of arrival, 5) angle of arrival, 6) combinations of the foregoing including triangulation techniques and other techniques known to those of skill in the art. In this regard, U.S. Pat. No. 6,765,492 and U.S. Pat. No. 6,624,752 is incorporated by reference herein.

FIG. 14 depicts a array of blocks 1400 through 1406 that include transmitters and have been assembled or positioned into a particular configuration. According to an embodiment of the invention, the arrangement of the blocks is then captured in an image and the image is processed according to the methods recited above and, the respective location of the blocks to one another is further determined using radiolocation techniques. Then the resulting output is compared to ensure that the output is consistent. In this embodiment the output from the image proceeding step is compared to the output from the radiolocation processor. Both outputs are then compared to the standard solution to increase the accuracy of the detection steps.

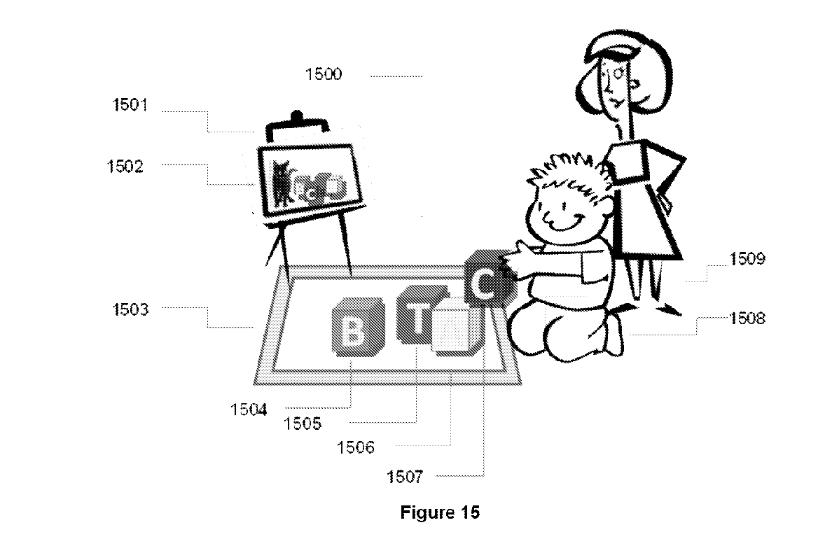

FIG. 15 depicts the image 1502 that includes letters on the respective blocks that are provided to the user. In other embodiments, letters can also be two dimensional cutouts or three dimensional letters as commonly used on refrigerators. The display 1502 as depicted on the display apparatus 1501, which may include a LED display, cathode ray display, plasma display or other graphic display device, communicates a reference standard to the user. In this case, the reference standard comprises the image of a cat. According to this embodiment, the user would then be prompted to arrange the lettered blocks to spell the word cat. A camera, that would be preferably oriented from the same perspective as the user would then take an image of the assembled blocks. Next, the images would be processed and in the processing step, optical character recognition (“OCR”) technology would be employed to identify the letters in the image and the order in which they were displayed. Such OCR technology is well known in the art an includes the teachings disclosed in U.S. Pat. No. 8,160,365, No. 8,077,930, No. 8,014,663, No. 8,045,798, No. 8,023,770 and No. 7,903,878 which are incorporated by referenced herein. The use of OCR technology can rapidly determine if the user properly arranged the blocks to conform to the reference standard. While other camera angles could be used, the processing step can be more rapidly accomplished if the orientation of the image is the same as that in the reference word. The reference standard may be displayed to the user with a picture of a desired solution word, the word itself may be depicted or, the solution may be in response to a question that is displayed to the user—For example, the display may ask the user to spell with the blocks the name of an animal that has whiskers.

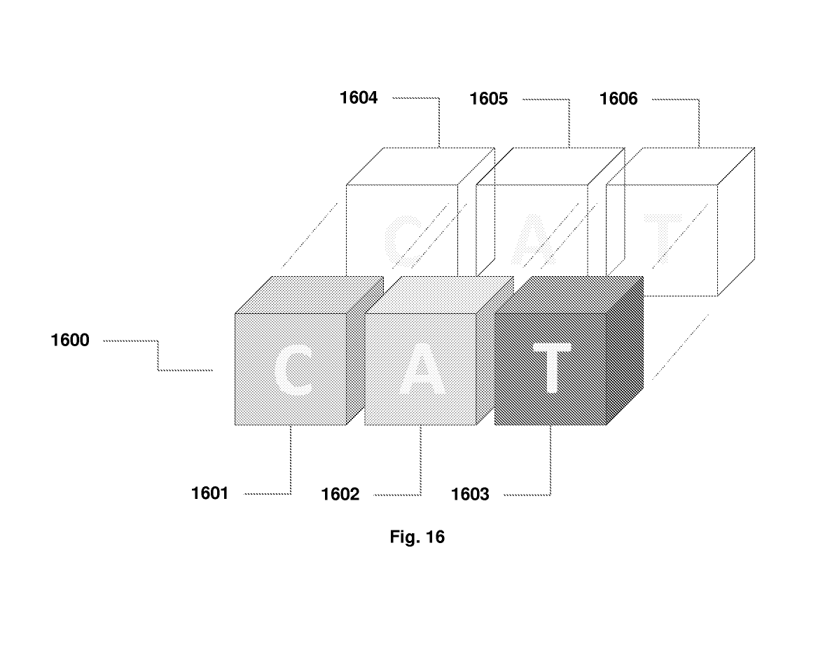

FIG. 16 depicts a schematic of the solution. In this regard, if the user has difficulty in assembling the blocks in the correct order to replicate the standard and reach the solution, the display can run a solution wherein the blocks displayed in a sequential arrangement to demonstrate the solution to the user. This sequence may be initiated after an incorrect solution is captured by the camera, or by a signal that is initiated by the user. Such signals may be detected by the system from an oral command or an input device (not shown) may be provided to allow the user to see a display of a solution of the problem. In embodiments, the solutions may be played at slow motion so that the user can appreciate each movement that is required to reach the solution or at other preselected speeds.

In other embodiments the system can play back the successful solution as a positive reinforcement tool. Other positive feedback may be provided such a pleasant chime or applause when the user implements the correct solution. Negative feedback such as the audio of “oops” or a “boooing” or “razzing” sound may be broadcast when the user presents the incorrect solution.

Other object recognition and object comparison software that can be used in accordance with the teaching of the invention can be acquired from vendors such as Image Graphics Video, a division of Dynamic Ventures, Inc., of Cupertino, Calif.;. Goepel electronic GMPH of Jena, Germany and Imagu Ltd., of Tel-Aviv, Israel. Cognex Corporation of Natick, Mass. has developed a commercially available software referred to as Patmax® that can be adapted for use with the invention and can integrate its solutions with various platforms. Other object recognition and comparison techniques that are well known in the object recognition field and can be employed in connection with the invention include the following: Normalized Cross Correlation as disclosed by Brown, L. G, 1992 A Survey of image registration techniques ACM computing Surveys 24(4) pp. 325-376; Hausdorff Distance as disclosed by Rucklidge, W. J 1997 Efficiently locating objects using Hausdorff Distance International Journal of Computer Vision 24(3) pp. 251-270; Shape Based Matching disclosed by Steger, C. 2001 Similarity measures for occlusion, clutter and illumination invariant object recognition. In:B. Radig and S. Florczyk (eds), Mustererkennung 2001, Springer, Munchen, pp. 148-154 and, as discussed above, Modified Hough Transform as disclosed inter alia by Ulrich M 2001, Real time object recognition in digital images for industrial applications. Technical Report PF-2002-01 Lehrstuhl fur Photogrammetrie and Fernerkundung, Technische Universitat Munchen. See also Performance Comparison of 2D Object Recognition Techniques, Ulrich M, Steger C Commission III, Working Group and III/5 and papers cited therein, all of which is incorporated by reference herein.

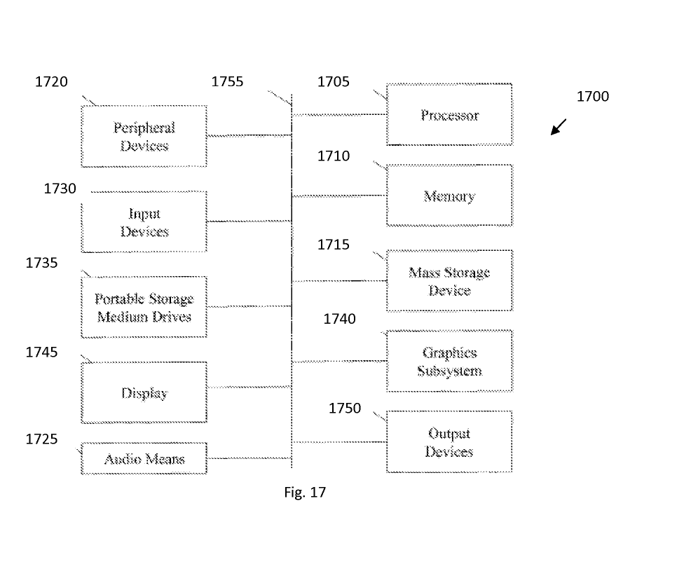

FIG. 17 is a block diagram of a data processing apparatus 1700 that can be incorporated as part of both the system. The data processing apparatus 1700 includes a processor 1705 for executing program instructions stored in a memory 1710. The memory 1710 stores instructions and data for execution by processor 305, including instructions and data for performing the methods described above. The data includes the various reference standards. Depending upon the extent of software implementation in data processing apparatus 1700, the memory 1710 stores executable code when in operation. The memory 1710 includes, for example, banks of read-only memory (ROM), dynamic random access memory (DRAM), as well as high-speed cache memory.

Referring to FIG. 17, within data processing apparatus 1700, an operating system comprises program instruction sequences that provide a platform for the methods described above. The operating system provides a software platform upon which application programs may execute, in a manner readily understood by those skilled in the art. The data processing apparatus 1700 further comprises one or more applications having program instruction sequences according to functional input for performing the methods described above.

The data processing apparatus 1700 incorporates any combination of additional devices. These include, but are not limited to, a mass storage device 1715, one or more peripheral devices 1720, a loudspeaker or audio means 1725, one or more input devices 1730 which may comprise a touchscreen, mouse or keyboard, one or more portable storage medium drives 1735, a graphics subsystem 1740, a display 1745, and one or more output devices 1750. The input devices in the present invention include a camera. The various components are connected via an appropriate bus 1755 as known by those skilled in the art. In alternative embodiments, the components are connected through other communications media known in the art. In one example, processor 1705 and memory 1710 are connected via a local microprocessor bus; while mass storage device 1715, peripheral devices 1720, portable storage medium drives 1735, and graphics subsystem 1740 are connected via one or more input/output buses.

In embodiments, computer instructions for performing methods in accordance with exemplary embodiments of the invention also are stored in processor 1705 or mass storage device 1715. The computer instructions are programmed in a suitable language such as C++.

In embodiments, the portable storage medium drive 1735 operates in conjunction with a portable non-volatile storage medium, such as a floppy disk, CD-ROM, or other computer-readable medium, to input and output data and code to and from the data processing apparatus 1700. In some embodiments, methods performed in accordance with exemplary embodiments of the invention are implemented using computer instructions that are stored on such a portable medium or are downloaded to said processor from a wireless link.

Peripheral devices 1720 include any type of computer support device, such as a network interface card for interfacing the data processing apparatus 1700 to a network or a modem.

Still referring to FIG. 17, the he graphics subsystem 1740 and the display 1745 provide output alternatives of the system. The graphics subsystem 1740 and display 1745 include conventional circuitry for operating upon and outputting data to be displayed, where such circuitry preferably includes a graphics processor, a frame buffer, and display driving circuitry. The display 1745 may include a cathode ray tube display, a liquid crystal display (LCD), a light emitting diode display (LED) or other suitable devices. The graphics subsystem 1740 receives textual and graphical information and processes the information for output to the display 1745.

Loudspeaker or audio means 1725 includes a sound card, on-board sound processing hardware, or a device with built-in processing devices that attach via Universal Serial Bus (USB) or IEEE 1394 (Firewire). The audio means may also include input mean such as a microphone for capturing and streaming audio signals.

In embodiments, instructions for performing methods in accordance with exemplary embodiments of the invention are embodied as computer program products. These generally include a storage medium having instructions stored thereon used to program a computer to perform the methods disclosed above. Examples of suitable storage medium or media include any type of disk including floppy disks, optical disks, DVDs, CD ROMs, magnetic or optical cards, hard disk, flash card, smart card, and other media known in the art.

Stored on one or more of the computer readable media, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable media further include software for performing the methods described above.

In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention.

It will be clear to one skilled in the art that the embodiments described above can be altered in many ways without departing from the scope of the invention. Accordingly, the scope of the invention should be determined by the following claims and their legal equivalents.

We claim:

1. A system to assist an operator with the assembly of objects, comprising
a camera to capture environmental images, a processor, a database comprising at least one reference standard image,
transmission links for transmitting data representing captured environmental image by said camera to said processor,
a processer to control the activation of said camera and receive functional input, wherein said functional input comprises operating conditions and said reference standard image, and
said processor executes control logic for processing said environmental images and for comparing said environmental images to said reference standard image, and
a display for the display of said reference images and said captured images.

2. The system of claim 1 wherein said control logic comprises object recognition software and image comparison software.

3. The system of claim 1 further comprising keyboard and mouse and wherein said functional input is selected an operator using said keyboard and mouse.

4. The system of claim 1 further comprising a touchscreen wherein said functional input is provided by an operator using a touchscreen.

5. The system of claim 1 wherein said database comprises a plurality of reference standard images that relate to the assembly.

6. The system recited in claim 1 wherein said processor further creates visual feedback image and said feedback image display a difference from said captured environmental image and said reference standard image.

7. The system recited in claim 1 wherein said database further comprises a visual instructional sequences of images and said visual instructional sequence is displayed at predetermined times and in response to operator input.

8. The system recited in claim 2 further comprising a loudspeaker to provide positive auditory feedback when said captured environmental images conform to said reference standard image as determined by said comparison software.

9. The system recited in claim 2 further comprising a loudspeaker to provide negative auditory feedback when said capture images does not conform to said reference standard as determined by said comparison software.

10. The system recited in claim 1 wherein said camera comprises a digital video camera and said processor further executes a frame grabber function.

11. The system recited in claim 1 wherein said transmission link comprises wireless communication.

12. The system recited in claim 1 further wherein said object comprises alphabet blocks and said reference standard comprises a series of letters representing a word or phrase.

13. The system of claim 1 wherein said camera, processor and said display further comprise a tablet computer.

14. The system recited in claim 2 wherein said object recognition software further comprising optical character recognition.

15. The system recited in claim 13 wherein said display further comprises a dashboard that provides for access to control processor and functional inputs for the system.

16. The system recited in claim 12 further comprising a reference field, and wherein said objects are located within said reference field and said processor uses said reference field in its logic.

17. The system recited in claim 16 wherein said reference field comprises a mat.

18. The system recited in claim 1 further comprising a stand for said camera, wherein the user can orient the stand to direct the camera at said objects.

19. The system recited in claim 1 wherein said reference field is a virtual graphical representation on a display screen and said operator can interpose said reference field on said image.

20. The system recited in claim 1 wherein said system further comprises objects and said objects comprise three dimensional items.

21. The system recited in claim 1 wherein said system further comprises objects and said objects further comprise alphanumeric symbols.

22. The system recited in claim 20 wherein said objects further comprise enhanced object detection elements.

23. The system recited in claim 22 wherein the system further comprises objects location sensors that provide input to said processor.

24. The system recited in claim 23 wherein said locations sensors comprise and RFID antennae.

25. The system recited in claim 1 wherein said system further comprises objects and said objects further comprise building blocks and wherein said reference standard comprise a structure.

26. The system recited in claim 22 wherein said enhanced object detection elements further comprises transmitters.

27. The system recited in claim 22 wherein said enhanced object detection elements further comprise RFID tags.

28. The system recited in claim further comprising a countdown timer wherein the time that is elapsed from the display of a first reference standard to the time when positive feedback is output is calculated counted.

29. The system recited in claim 28 wherein said time elapsed is compared to other times calculated and the time is displayed to the user.

30. The system recited in claim 28 wherein information relating to the time calculated and the reference standard is transmitted to a remote location.

31. The system recited in claim 1 wherein the said functional input further comprises the user activation of said camera to capture said environmental image.

32. The system recited in claim 1 wherein an image from said camera is captured and transmitted to said processor after predetermined time intervals.

33. The system recited in claim 1 wherein said camera detects motion in said and an image is captured and transmitted after a predetermined time after the cessation of the detection of motion.

34. A method for instructing a user to assemble a objects to make an assembly, comprising a first step of displaying a reference standard on a display screen relating to said assembly, a second step of capturing environmental images with a camera as the user assembles said objects, using a processor to process said images to compare said captured image to a reference images, a further step of providing either positive or negative feedback to the user reflecting whether the environmental captured image conforms or does not conform to said reference standard.

35. The method recited in claim 34 wherein said positive or negative feedback further comprises and auditory signal.

36. The method as recited in claim 34 wherein said feedback further comprises graphic indicia on said display screen that simulates a correct assembly as exemplified in a reference standard superimposed on a captured environmental image.

37. The method recited in claim 34 wherein said reference standard further comprises the alignment of alphanumeric characters in a predetermined sequence.

38. The method recited in claim 34 wherein said processing step is performed in a location remote from said objects.

39. A method to assist in the instruction of spelling a target word using tangible letters, said method comprising a first step of displaying an image on a display screen relating to a said target word, a further step of capturing environmental images with a camera as the user orients said letters, using a processor to process said images to compare said captured image to said target word, a further step of providing either positive or negative feedback to the user reflecting whether the environmental captured image conforms or does not conform to said target word.

40. A method to assist in the instruction of spelling a target word using tangible letters, said method comprising a first step of providing an auditory signal pronouncing said target word, a further step of capturing environmental images as the user orients said letters, using a processor to process said images to compare said captured image to said target word, a further step of providing either positive or negative feedback to the user reflecting whether the environmental captured image conforms or does not conform to said target word.
